(19) United States
(12) Patent Application Publication
(10) Pub. No.: US 2023/0418618 A1
(43) Pub. Date: Dec. 28, 2023

(54) COMPUTER INTELLIGENT SWITCHING SYSTEM AND METHOD THEREOF

(71) Applicant: EVGA CORPORATION, New Taipei (TW)

(72) Inventor: TAI-SHENG HAN, New Taipei (TW)

(21) Appl. No.: 17/849,551

(22) Filed: Jun. 24, 2022

(51) Int. Cl. G06F 9/4401; G06F 1/26

(52) U.S. Cl. CPC G06F 9/4401; G06F 1/26

(57) ABSTRACT

A computer intelligent switching system and a method thereof comprise a portable object and a circuit baseplate, the portable object is used to send a broadcast packet with a Bluetooth address (BD address), the circuit baseplate is disposed in a computer device and electrically connected to a motherboard of the computer device. After a series of comparison and confirmation procedures between the circuit baseplate and the portable object, the circuit baseplate determines whether to execute an operation on the computer device or disconnect connection with the portable object to re-enter a detection procedure according to a replied signal.

### BACKGROUND OF THE INVENTION

### Field of Invention

The invention relates to a computer switching system, and more particularly to a computer intelligent switching system and a method thereof capable of greatly reducing a time waiting for switching on and off a computer to greatly improve a work efficiency.

### Related Art

Computers have been widely used in people's lives, and computers can replace human beings to handle various mathematical operations.

Generally speaking, the startup of a computer device is carried out by the user pressing the power button of the computer device, and the computer device executes the wake-up procedure or the boot procedure. In addition, when the user wishes to display the computer screen of the computer device through an external monitor, the user must first execute the wake-up procedure or the boot procedure, and execute the corresponding setting procedure before using the external monitor to display the computer screen. Therefore, it is quite inconvenient for users who need to use computer every day, and also a lot of time is spent on waiting for the procedures of switching on and off the computer to be executed, resulting in poor work efficiency.

Therefore, the relevant manufacturers engaged in this industry are eager to research and make improvement to solve the above-mentioned problems and drawbacks in the prior art.

### SUMMARY OF THE INVENTION

Therefore, in order to effectively solve the above-mentioned problems, a main object of the invention is to provide a computer intelligent switching system capable of greatly reducing a time waiting for switching on and off a computer.

A secondary object of the invention is to provide a computer intelligent switching system capable of greatly improving a work efficiency.

Another secondary object of the invention is to provide a computer intelligent switching method capable of greatly reducing a time waiting for switching on and off a computer.

Another secondary object of the invention is to provide a computer intelligent switching method capable of greatly improving a work efficiency.

In order to achieve the above objects, the invention provides a computer intelligent switching system comprising a portable object and a circuit baseplate, the portable object is used to send a broadcast packet with a Bluetooth address (BD address), the circuit baseplate is disposed in a computer device and electrically connected to a motherboard of the computer device; the circuit baseplate has a first micro-processing unit, the first micro-processing unit comprises a Bluetooth wireless communication module and a first storage module, the first micro-processing unit activates a detection mode through the Bluetooth wireless communication module to detect surrounding broadcast packets, and determines by comparing a received signal with a Bluetooth address stored in the first storage module, after confirmation by comparison, a connection request signal and a Bluetooth address that has been compared successfully are generated to the portable object, so that the portable object generates a connection confirmation signal and sends the connection confirmation signal to the circuit baseplate after confirmation by comparison according to the connection request signal and the Bluetooth address that has been compared successfully, the first micro-processing unit of the circuit baseplate sends an identification request command and a random code to the portable object according to the connection confirmation signal, the identification request command requests the portable object to provide an identification request information and a corresponding code corresponding to the random code to send back to the circuit baseplate, the circuit baseplate obtains the identification request information and the corresponding code, after confirmation by comparison, a replied signal is generated to the portable object, and the circuit baseplate determines whether to execute an operation on the computer device or disconnect connection with the portable object to re-enter a detection procedure according to the replied signal.

In one embodiment, the identification request information further comprises a company identification code, a product identification code and a product name.

In one embodiment, the random code is stored in a first comparison table of a first database of the first storage module, the corresponding code is stored in a second comparison table of a second database of a second storage module in a second micro-processing unit of the portable object, the first and second comparison tables both contain 256 sets of different 2-byte digital contents, the first and second comparison tables both have the random code and the corresponding code, the random code represents serial numbers (No. 0 to 255), the corresponding code represents 2-byte digital passwords of each of the sets, when the first micro-processing unit of the circuit baseplate sends the identification request command, the random code is sent to the portable object at the same time, after receiving the random code, the portable object finds the corresponding code corresponding to the random code from the second comparison table and sends the corresponding code to the circuit baseplate.

In one embodiment, the first micro-processing unit of the circuit baseplate confirms a signal strength with the portable object through the Bluetooth wireless communication module, converts the signal strength into a distance value, and confirms whether the distance value is less than or greater than a specified distance through a determination module, and the computer device executes turn-on, wake-up, sleep or shutdown mode according to the specified distance.

In one embodiment, a light-emitting diode (LED) is further provided on the motherboard of the computer device and is electrically connected to the first micro-processing unit of the circuit baseplate, and determining to generate a command signal by observing whether the light-emitting diode is lit up or not.

In one embodiment, the command signal further comprises a wake-up signal or a turn-on signal, and the computer device executes operations according to the wake-up signal or the turn-on signal.

In order to achieve the above objects, the invention provides a computer intelligent switching method comprising following steps of:
a portable object sending a broadcast packet with a Bluetooth address (BD address);
inside a computer device being provided with a circuit baseplate electrically connected to a motherboard of the computer device, a first micro-processing unit comprising a Bluetooth wireless communication module and a first storage module being provided in the circuit baseplate, the first micro-processing unit activating a detection mode via the Bluetooth wireless communication module to detect surrounding broadcast packets, and determining by comparing a received signal with a Bluetooth address stored in the first storage module, after confirmation by comparison, generating a connection request signal and a successfully compared Bluetooth address to the portable object;
the portable object generating a connection confirmation signal and sending the connection confirmation signal to the circuit baseplate after confirmation by comparison according to the connection request signal and the successfully compared Bluetooth address;
the first micro-processing unit of the circuit baseplate sending an identification request command and a random code to the portable object according to the connection confirmation signal;
the identification request command requesting the portable object to provide an identification request information and a corresponding code corresponding to the random code to send back to the circuit baseplate;
the circuit baseplate obtaining the identification request information and the corresponding code, after confirmation by comparison, generating a replied signal to the portable object; and
the circuit baseplate determining whether to execute an operation on the computer device or disconnecting connection with the portable object to re-enter a detection procedure according to the replied signal.

In one embodiment, after the step of generating the connection request signal and the successfully compared Bluetooth address to the portable object, further comprising:
if the Bluetooth address of the portable object being incorrectly compared, meaning failed connection, the portable object sending the broadcast packet and the circuit baseplate activating the detection procedure again.

In one embodiment, after the random code from the circuit baseplate and the corresponding code collected from the portable object are determined by comparison, if a comparison result is correct, a reply signal is generated and sent to the portable object, if a comparison result is wrong, a replied signal is also generated to notify the portable object, the successfully compared Bluetooth address is disconnected at the same time, and the Bluetooth wireless communication module re-enters to activate the detection mode.

In one embodiment, after the step of the circuit baseplate obtaining the identification request information and the corresponding code, after confirmation by comparison, generating the replied signal to the portable object, further comprising:
the first micro-processing unit of the circuit baseplate confirming a signal strength with the portable object through the Bluetooth wireless communication module and converting the signal strength into a distance value;
confirming whether the distance value being less than or greater than a specified distance through a determination module;
if the distance value being determined to be less than the specified distance, further determining whether the computer device being turned on or woken up; and
if the distance value being determined to be greater than the specified distance, the determination module continuing to confirm a distance.

In one embodiment, a light-emitting diode (LED) is further provided on the motherboard of the computer device and is electrically connected to the first micro-processing unit, and determining to generate a command signal by observing whether the light-emitting diode is lit up or not.

In one embodiment, after the step of if the distance value being determined to be less than the specified distance, further comprising:
determining to generate a command signal by observing whether the light-emitting diode of the computer device being lit up or not; and
if the light-emitting diode being in a non-light up state, sending a wake-up signal or a turn-on signal of the command signal to the computer device, and the computer device executing a wake-up operation or a turn-on operation according to the wake-up signal or the turn-on signal.

In one embodiment, after the step of determining to generate the command signal by observing whether the light-emitting diode of the computer device being lit up or not, further comprising:
if the light-emitting diode being lit up, the Bluetooth wireless communication module of the first micro-processing unit confirming a signal strength with the portable object and converting the signal strength into the distance value, and determining whether the distance value being greater than the specified distance through the determination module and generating the command signal; and
if the determination module determining that the distance value being greater than the specified distance, sending a sleep signal or a shutdown signal of the command signal to the computer device to execute a sleep operation or a shutdown operation.

In one embodiment, when the determination module determines that the distance value is greater than the specified distance, the first micro-processing unit is connected to a USB port on the motherboard of the computer device through a USB port in the first micro-processing unit, and the sleep signal is sent to the computer device from the USB port of the first micro-processing unit to make the computer device execute the sleep operation, or the first micro-processing unit is electrically connected to a power button of the motherboard of the computer device through an IO pin in the first micro-processing unit to send the shutdown signal to make the computer device execute the shutdown operation.

In one embodiment, the first micro-processing unit further has a distance determination module, the Bluetooth wireless communication module of the first micro-processing unit determines whether a connection with the portable object is disconnected through the distance determination module, if yes, it is determined that the connection fails, and the portable object sends the broadcast packet and the circuit baseplate activates the detection procedure again, if not, return to the step of determining the distance value.

In one embodiment, the identification request information comprises a company identification code, a product identification code and a product name.

In one embodiment, the random code is stored in a first comparison table of a first database of the first storage module, the corresponding code is stored in a second comparison table of a second database of a second storage module in a second micro-processing unit of the portable object, the first and second comparison tables both contain 256 sets of different 2-byte digital contents, the first and second comparison tables both have the random code and the corresponding code, the random code represents serial numbers (No. 0 to 255), the corresponding code represents 2-byte digital passwords of each of the sets, when the first micro-processing unit of the circuit baseplate sends the identification request command, the random code is sent to the portable object at the same time, after receiving the random code, the portable object finds the corresponding code corresponding to the random code from the second comparison table and sends the corresponding code to the circuit baseplate.

Through the computer intelligent switching system and the method thereof of the invention, the portable object and the circuit baseplate use wireless received signal strength indication (RSSI) to determine a proximity distance between the portable object and the computer device through wireless communication. If a user approaches the computer device, the system will sense it, enter a welcome mode, and execute relevant operation procedures according to a state of the computer device. When the user moves away from the computer device, the computer device will automatically enter the sleep operation or the shutdown operation, thereby capable of greatly reducing a time waiting for switching on and off the computer device to greatly improve a work efficiency.

### BRIEF DESCRIPTION OF THE DRAWINGS

FIG. 1 is a schematic structural diagram of a computer intelligent switching system of the invention;

FIG. 2 is a system block diagram of the computer intelligent switching system of the invention;

FIG. 3 is a schematic diagram of first and second comparison tables of the invention;

FIG. 4 is a flow chart of steps of a computer intelligent switching method of the invention;

FIG. 5 is a schematic diagram of operation procedures of the computer intelligent switching method of the invention;

FIG. 6 is another flow chart of the steps of the computer intelligent switching method of the invention;

FIG. 7 is another flow chart of the steps of the computer intelligent switching method of the invention;

FIG. 8 is another system block diagram of the computer intelligent switching system of the invention; and

FIG. 9 is another flow chart of the steps of the computer intelligent switching method of the invention.

### DETAILED DESCRIPTION OF THE INVENTION

The above objects of the invention, as well as its structural and functional features, will be described in accordance with the preferred embodiments of the accompanying drawings.

In the following, for the formation and technical content related to a computer intelligent switching system and a method thereof of the invention, various applicable examples are exemplified and explained in detail with reference to the accompanying drawings; however, the invention is of course not limited to the enumerated embodiments, drawings, or detailed descriptions.

Furthermore, those who are familiar with this technology should also understand that the enumerated embodiments and accompanying drawings are only for reference and explanation, and are not used to limit the invention; other modifications or alterations that can be easily implemented based on the detailed descriptions of the invention are also deemed to be within the scope without departing from the spirit or intention thereof as defined by the appended claims and their legal equivalents.

And, the directional terms mentioned in the following embodiments, for example: “above”, “below”, “left”, “right”, “front”, “rear”, etc., are only directions referring in the accompanying drawings. Therefore, the directional terms are used to illustrate rather than limit the invention. In addition, in the following embodiments, the same or similar elements will be labeled with the same or similar numerals.

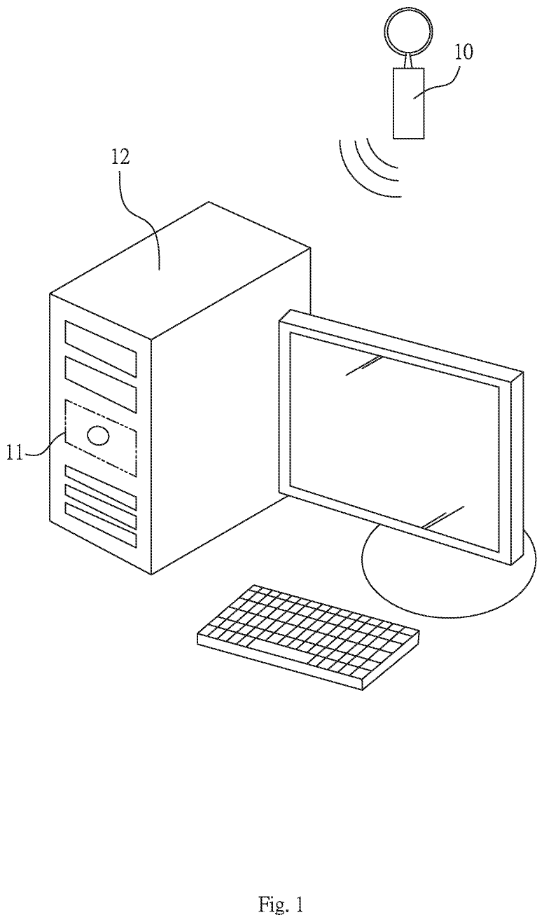

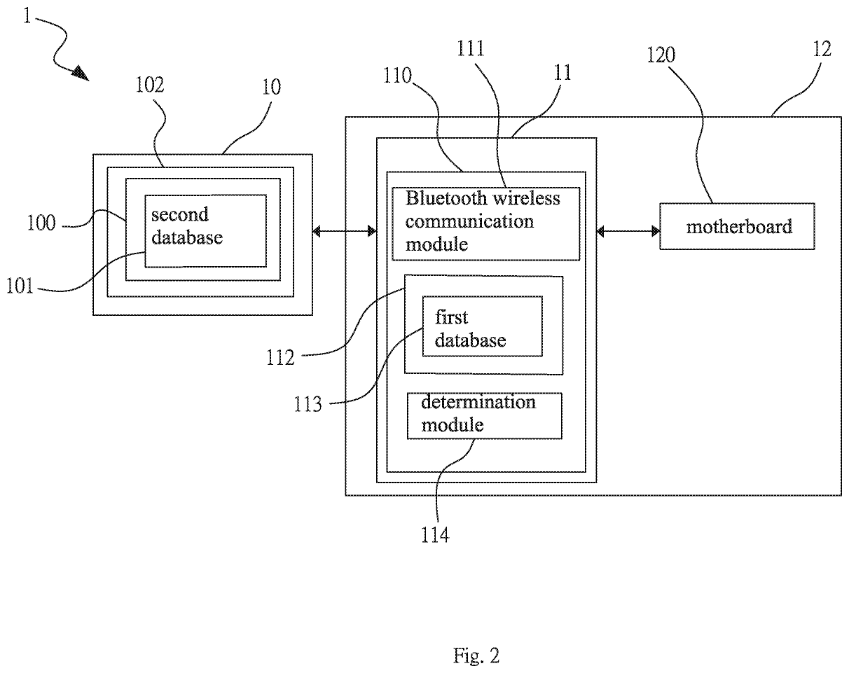

Please refer to FIGS. 1 and 2 for a schematic structural diagram; and a system block diagram of a computer intelligent switching system of the invention respectively. As shown in the figures, a computer intelligent switching system 1 comprises a portable object 10 and a circuit baseplate 11. The portable object 10 is illustrated by a key ring in this embodiment. The key ring comprises a circuit, a first micro-processing unit 110 and a battery. In actual implementation, all objects (such as: card, magnetic buckle, etc.) that are portable on the body are included in the scope of the present invention.

The portable object 10 is used for sending a broadcast packet with a Bluetooth address (BD address). The circuit baseplate 11 is installed in a computer device 12 and is electrically connected to a motherboard 120 of the computer device 12. The computer device 12 in this specification is a desktop computer, the circuit baseplate 11 has the first micro-processing unit 110, and the first micro-processing unit 110 comprises a Bluetooth wireless communication module 111 and a first storage module 112. The first micro-processing unit 110 activates a detection mode through the Bluetooth wireless communication module 111 to detect surrounding broadcast packets, and determines by comparing a received signal with a Bluetooth address stored in the first storage module 112, after confirmation by comparison, a connection request signal and a Bluetooth address that has been compared successfully are generated to the portable object 10. A second micro-processing unit 102 of the portable object 10 will generate a connection confirmation signal and send the connection confirmation signal to the first micro-processing unit 110 of the circuit baseplate 11 after confirmation by comparison according to the connection request signal and the successfully compared Bluetooth address.

The first micro-processing unit 110 of the circuit baseplate 11 sends an identification request command and a random code 20 to the portable object 10 according to the connection confirmation signal. Then, the identification request command requests the portable object 10 to provide an identification request information and a corresponding code 21 corresponding to the random code 20 to send back to the circuit baseplate 11. Wherein it should be explained that the identification request information further comprises a company identification code, a product identification code and a product name.

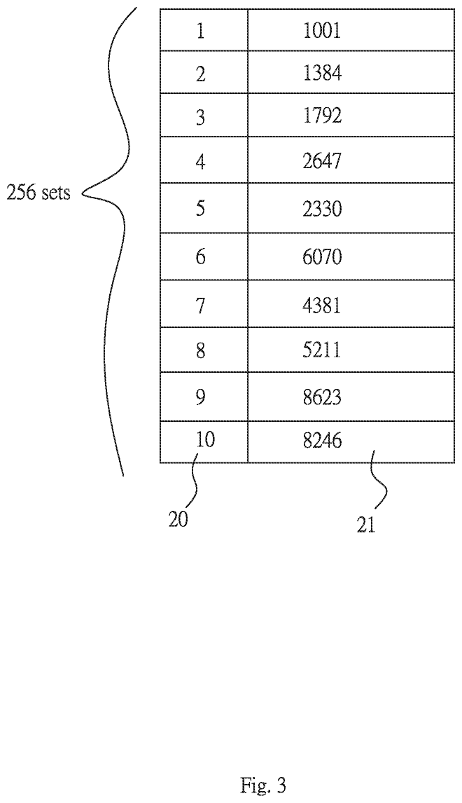

A comparison process of the random code 20 and the corresponding code 21 is further described. The random code 20 is stored in a first comparison table of a first database 113 of the first storage module 112, and the corresponding code 21 is stored in a second comparison table of a second database 101 of a second storage module 100 of the second micro-processing unit 102 of the portable object 10. The first and second comparison tables both comprise 256 sets of different 2-byte digital contents, and both the first and second comparison tables have the same random code 20 and the same corresponding code 21 (please refer to FIG. 3). The random code 20 represents serial numbers, which start numbering from No. 0 to No. 255, the corresponding code 21 represents 2-byte digital passwords of each of the sets. When the first micro-processing unit 110 of the circuit baseplate 11 sends the identification request command, the random code 20 is sent to the portable object 10 at the same time, after receiving the random code 20, the second storage module 100 of the portable object 10 finds the corresponding code 21 corresponding to the random code 20 from the second comparison table and sends the corresponding code 21 to the circuit baseplate 11.

The first micro-processing unit 110 of the circuit baseplate 11 obtains the identification request information and the corresponding code 21, after confirmation by comparison, a replied signal is generated to the portable object 10, and the first micro-processing unit 110 of the circuit baseplate 11 determines whether to execute an operation on the computer device 12 or disconnect connection with the portable object 10 to re-enter a detection procedure according to the replied signal.

After the random code 20 from the circuit baseplate 11 and the corresponding code 21 collected from the portable object 10 are determined by comparison, if a comparison result is correct, the first micro-processing unit 110 confirms a signal strength with the portable object 10 through the Bluetooth wireless communication module 111, converts the signal strength into a distance value, and confirms whether the distance value is less than or greater than a specified distance through a determination module 114, and the computer device 12 executes turn-on, wake-up, sleep or shutdown mode according to the specified distance.

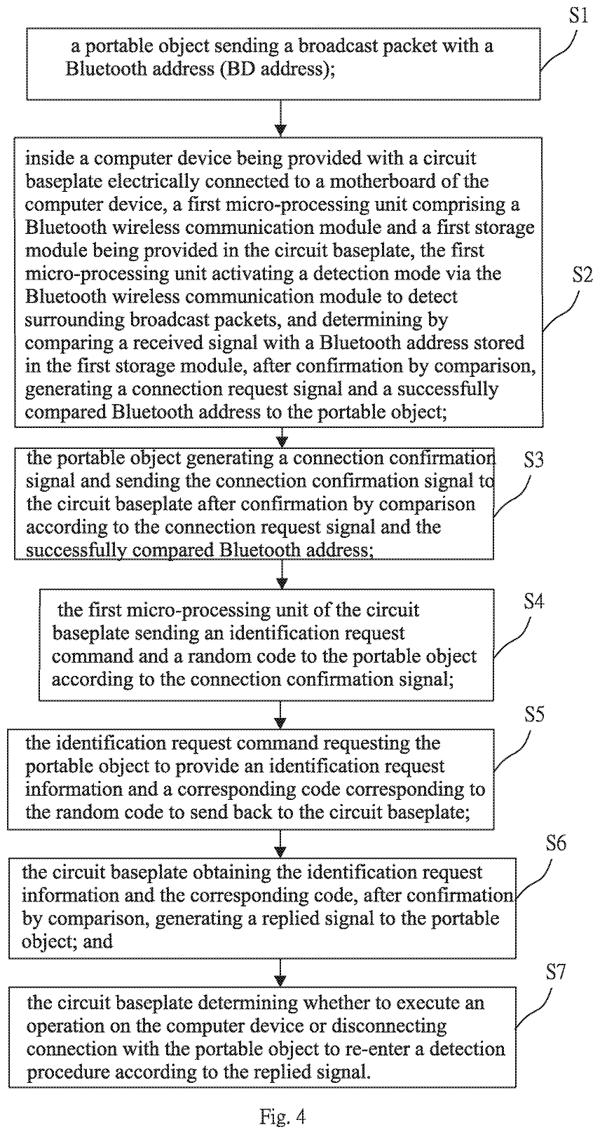

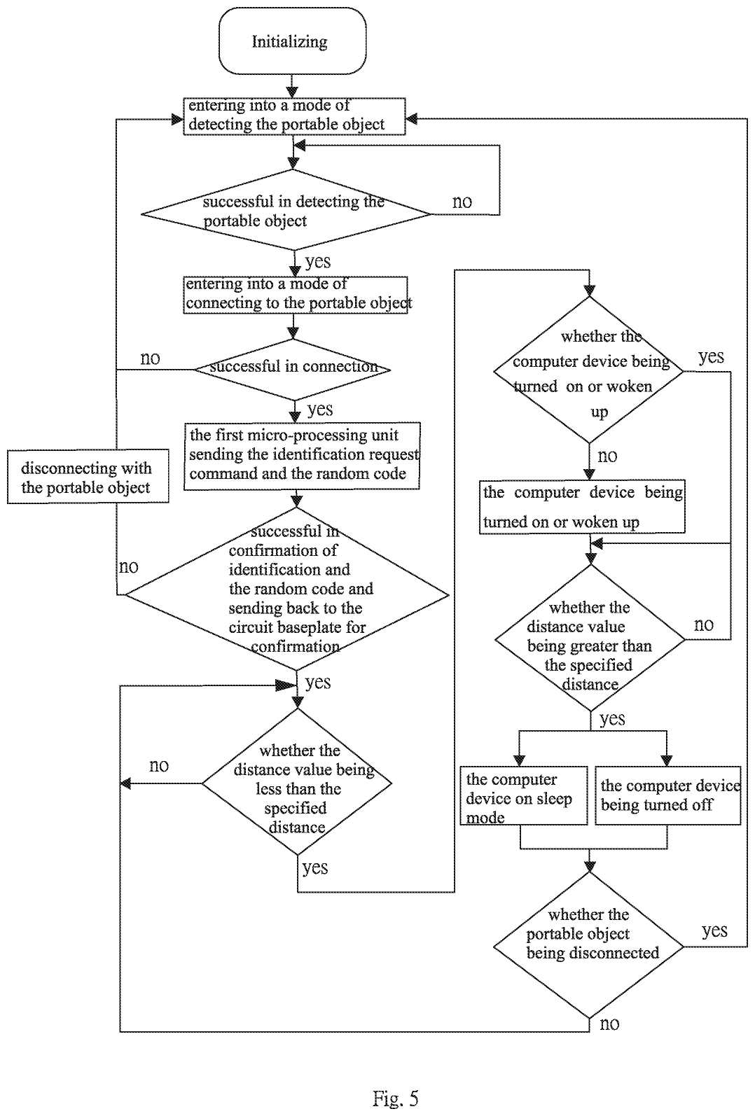

In order to clearly describe operation procedures of the invention, please refer to FIG. 4 and FIG. 5 for a flow chart of steps; and a schematic diagram of operation procedures of a computer intelligent switching method of the invention respectively.

The computer intelligent switching method of the invention comprises following steps of:
S1: a portable object sending a broadcast packet with a Bluetooth address (BD address);
S2: inside a computer device being provided with a circuit baseplate electrically connected to a motherboard of the computer device, a first micro-processing unit comprising a Bluetooth wireless communication module and a first storage module being provided in the circuit baseplate, the first micro-processing unit activating a detection mode via the Bluetooth wireless communication module to detect surrounding broadcast packets, and determining by comparing a received signal with a Bluetooth address stored in the first storage module, after confirmation by comparison, generating a connection request signal and a successfully compared Bluetooth address to the portable object;
S3: the portable object generating a connection confirmation signal and sending the connection confirmation signal to the circuit baseplate after confirmation by comparison according to the connection request signal and the successfully compared Bluetooth address;
S4: the first micro-processing unit of the circuit baseplate sending an identification request command and a random code to the portable object according to the connection confirmation signal;
S5: the identification request command requesting the portable object to provide an identification request information and a corresponding code corresponding to the random code to send back to the circuit baseplate;
S6: the circuit baseplate obtaining the identification request information and the corresponding code, after confirmation by comparison, generating a replied signal to the portable object; and
S7: the circuit baseplate determining whether to execute an operation on the computer device or disconnecting connection with the portable object to re-enter a detection procedure according to the replied signal.

In order to facilitate description of an overall operation process, the following description takes the portable object 10, the computer device 12 and the circuit baseplate 11 as three independent components. It should be explained that the circuit baseplate 11 is disposed in the computer device 12 and is electrically connected to the motherboard 120 of the computer device 12, and the portable object 10 is connected to the circuit baseplate 11 through wireless communication. Wherein detailed operations of the internal components can be referred to the above description. Firstly, when a user holds the portable object 10, the portable object 10 continuously sends the broadcast packet with the Bluetooth address, the first micro-processing unit 110 of the circuit baseplate 11 activates a detection mode through the Bluetooth wireless communication module 111 to detect surrounding broadcast packets, and determines by comparing the received signal with the Bluetooth address stored in the first storage module 112, after confirmation by comparison, the connection request signal and the Bluetooth address that has been compared successfully are generated to the portable object 10. The second micro-processing unit 102 of the portable object 10 generates a connection confirmation signal and sends the connection confirmation signal to the circuit baseplate 11 after confirmation by comparison according to the connection request signal and the successfully compared Bluetooth address. The first micro-processing unit 110 of the circuit baseplate 11 sends the identification request command and the random code 20 to the portable object 10 according to the connection confirmation signal. The identification request command requests the portable object 10 to provide the identification request information and the corresponding code 21 corresponding to the random code 20 to send back to the circuit baseplate 11. The first micro-processing unit 110 of the circuit baseplate 11 obtains the identification request information and the corresponding code 21, after confirmation by comparison, the replied signal is generated to the portable object 10, and the first micro-processing unit 110 of the circuit baseplate 11 determines whether to execute an operation on the computer device 12 or disconnect connection with the portable object 10 to re-enter a detection procedure of the circuit baseplate 11 according to the replied signal.

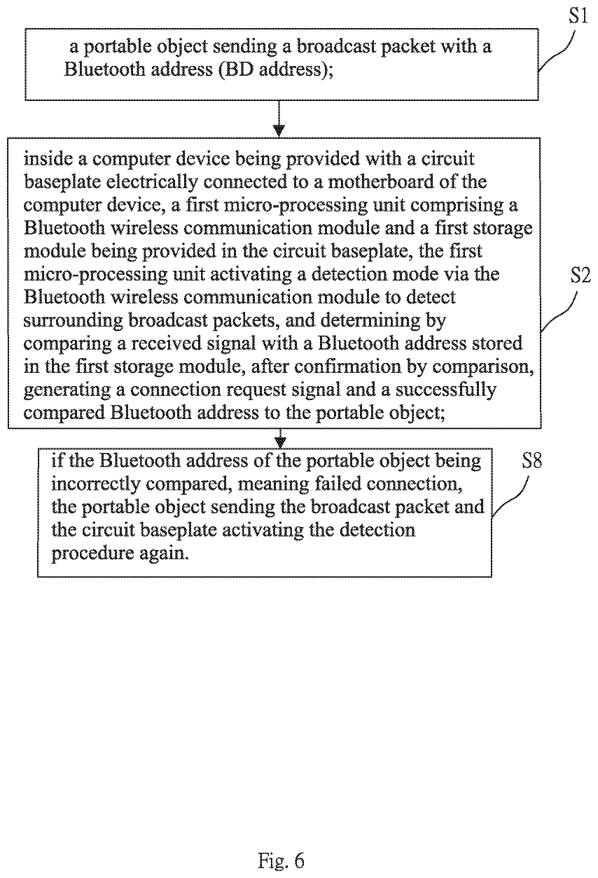

Please refer to FIG. 6 as well for a more detailed description of the above-mentioned operation procedures, wherein after step S2: generating the connection request signal and the successfully compared Bluetooth address to the portable object, further comprising step S8: if the Bluetooth address of the portable object 10 being incorrectly compared, meaning failed connection, the portable object 10 sending the broadcast packet and the circuit baseplate 11 activating the detection procedure again.

In addition, referring to FIG. 5 again, it should be explained that when steps S4 to S6 are executed, after the random code 20 from the circuit baseplate 11 and the corresponding code 21 collected from the portable object 10 are determined by comparison, if a comparison result is correct, a reply signal is generated and sent to the second micro-processing unit 102 of the portable object 10, if a comparison result is wrong, a replied signal is also generated to notify the second micro-processing unit 102 of the portable object 10, the successfully compared Bluetooth address is disconnected at the same time, and the Bluetooth wireless communication module 111 re-enters to activate the detection mode.

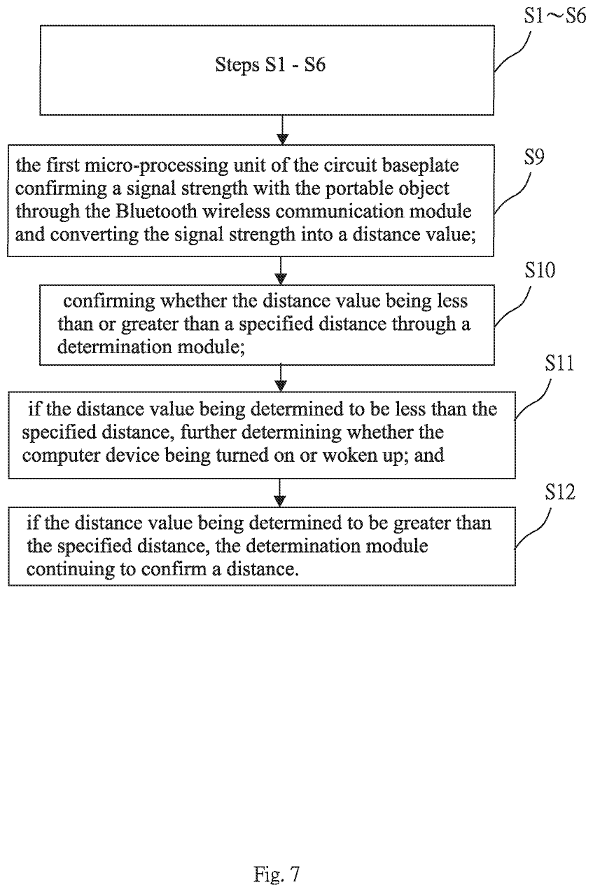

Please refer to FIG. 7, after the step of the circuit baseplate obtaining the identification request information and the corresponding code, after confirmation by comparison, generating the replied signal to the portable object, further comprising steps of:
S9: the first micro-processing unit of the circuit baseplate confirming a signal strength with the portable object through the Bluetooth wireless communication module and converting the signal strength into a distance value;
S10: confirming whether the distance value being less than or greater than a specified distance through a determination module;
S11: if the distance value being determined to be less than the specified distance, further determining whether the computer device being turned on or woken up; and
S12: if the distance value being determined to be greater than the specified distance, the determination module continuing to confirm a distance.

In other words, the first micro-processing unit 110 of the circuit baseplate 11 obtains the identification request information and the corresponding code 21, after confirmation by comparison, the replied signal is generated to the portable object 10. The first micro-processing unit 110 confirms a signal strength with the portable object 10 through the Bluetooth wireless communication module 111, converts the signal strength into the distance value, and the determination module 114 in the first micro-processing unit 110 determines and confirms whether the distance value is less than or greater than the specified distance (the specified distance has been set before the system 1 leaves the factory). If the distance value is determined to be less than the specified distance by the determination module 114, it is further determined whether the computer device 12 has been turned on or woken up, contrarily, if the distance value is determined to be greater than the specified distance by the determination module 114, the determination module 114 continues to confirm a distance.

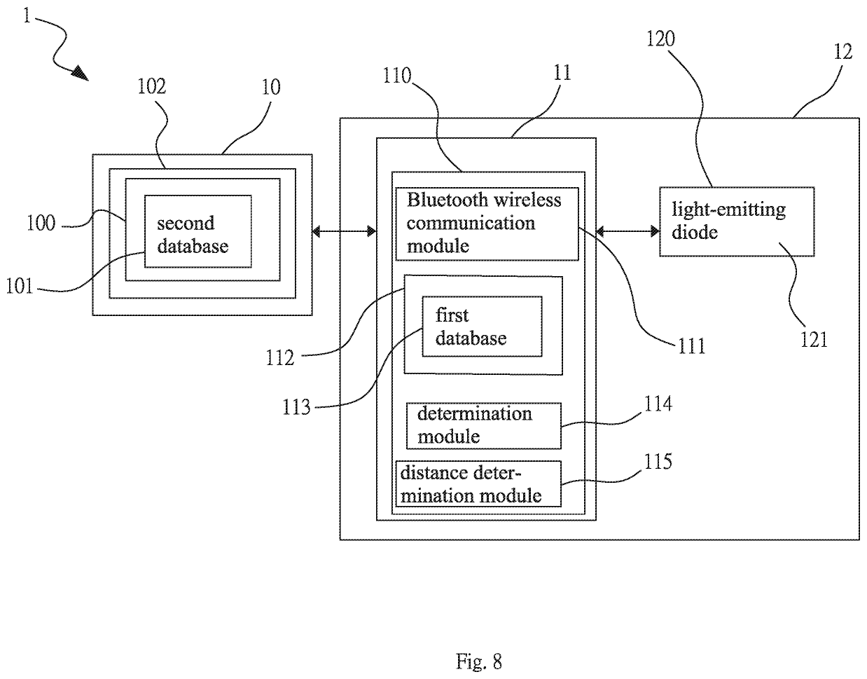

Please refer to FIG. 8 as well, the motherboard 120 of the computer device 12 is further provided with a light-emitting diode 121 (LED), the light-emitting diode 121 is electrically connected to the first micro-processing unit 110, and determining to generate a command signal by observing whether the light-emitting diode 121 is lit up or not.

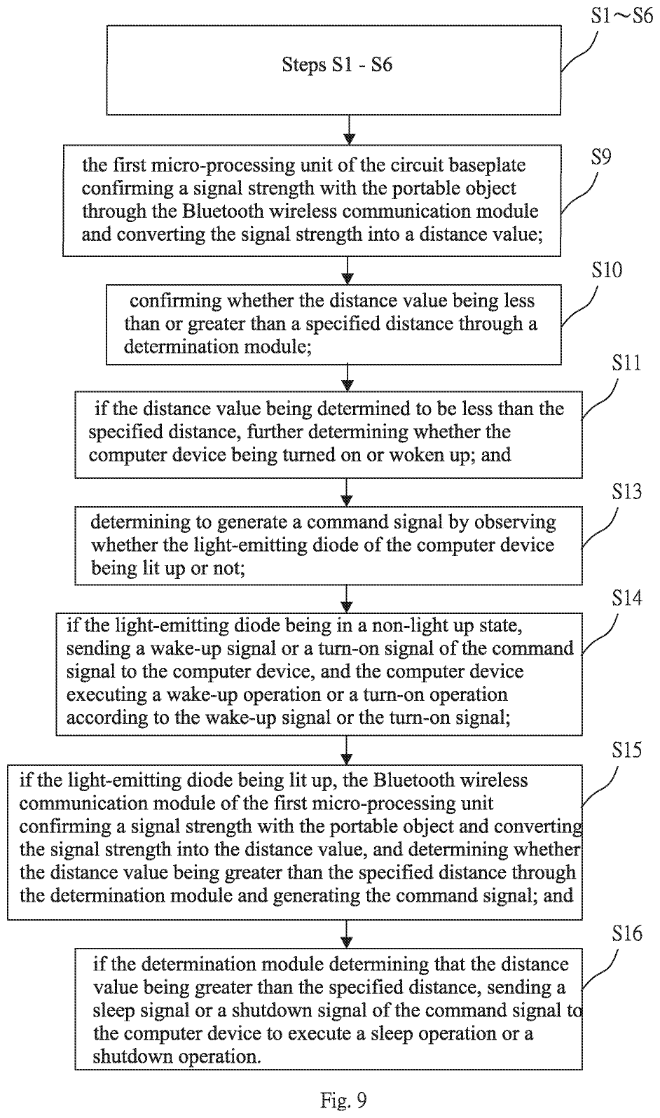

Please refer to FIG. 9 as well for further description, after step S11, further comprising steps of:
S13: determining to generate a command signal by observing whether the light-emitting diode of the computer device being lit up or not;
S14: if the light-emitting diode being in a non-light up state, sending a wake-up signal or a turn-on signal of the command signal to the computer device, and the computer device executing a wake-up operation or a turn-on operation according to the wake-up signal or the turn-on signal;
S15: if the light-emitting diode being lit up, the Bluetooth wireless communication module of the first micro-processing unit confirming a signal strength with the portable object and converting the signal strength into the distance value, and determining whether the distance value being greater than the specified distance through the determination module and generating the command signal; and
S16: if the determination module determining that the distance value being greater than the specified distance, sending a sleep signal or a shutdown signal of the command signal to the computer device to execute a sleep operation or a shutdown operation.

That is to say, whether the light-emitting diode 121 on the computer device 12 is lit up or not is used to determine and generate the command signal. If the light-emitting diode 121 is not lit up, the wake-up signal or the turn-on signal of the command signal will be sent to the computer device 12, and the computer device 12 executes the wake-up operation or the turn-on operation according to the wake-up signal or the turn-on signal. If the light-emitting diode 121 is lit up, the Bluetooth wireless communication module 111 confirms a signal strength with the portable object 10 and converts the signal strength into the distance value, and determines whether the distance value is greater than the specified distance through the determination module 114 and generates the command signal. If the determination module 114 determines that the distance value is greater than the specified distance, the first micro-processing unit 110 is connected to a USB port on the motherboard 120 of the computer device 12 through a USB port in the first micro-processing unit 110, and the sleep signal is sent to the computer device 12 from the USB port of the first micro-processing unit 110 to make the computer device 12 execute the sleep operation, or the first micro-processing unit 110 is electrically connected to a power button on the motherboard 120 of the computer device 12 through an IO pin in the first micro-processing unit 110 to send the shutdown signal to the computer device 12 to make the computer device 12 execute the shutdown operation.

Please refer to FIG. 8 again for another system block diagram of the computer intelligent switching system of the invention. Inside the first micro-processing unit 110 of the circuit baseplate 11 of the system 1 further has a distance determination module 115, the Bluetooth wireless communication module 111 of the first micro-processing unit 110 determines whether a connection with the portable object 10 is disconnected through the distance determination module 115, if determining to be in a disconnected state, it is determined that the connection fails, the portable object 10 sends the broadcast packet and the circuit baseplate 11 activates the detection procedure again; if determining to be in a connected state, return to the steps of determining the distance value, that is, the determining procedures after the step S9.

Therefore, through the computer intelligent switching system and the method thereof of the invention, the portable object 10 and the circuit baseplate 11 use wireless received signal strength indication (RSSI) to determine a proximity distance between the portable object 10 and the computer device 12 through wireless communication. If the user approaches the computer device 12, the system 1 will sense it, enter a welcome mode, and execute relevant operation procedures according to a state of the computer device 12. When the user moves away from the computer device 12, the computer device 12 will automatically enter the sleep operation or the shutdown operation, thereby capable of greatly reducing a time waiting for switching on and off the computer device 12 to greatly improve a work efficiency.

In summary, the invention has the following advantages compared with the prior art:
1. capable of greatly reducing a time waiting for switching on and off a computer; and
2. capable of greatly improving a work efficiency.

It is to be understood that the above description is only preferred embodiments of the invention and is not used to limit the invention, and changes in accordance with the concepts of the invention may be made without departing from the spirit of the invention, for example, the equivalent effects produced by various transformations, variations, modifications and applications made to the configurations or arrangements shall still fall within the scope covered by the appended claims of the invention.

What is claimed is:

1. A computer intelligent switching system comprising:
a portable object, the portable object being used to send a broadcast packet with a Bluetooth address (BD address); and
a circuit baseplate disposed in a computer device and electrically connected to a motherboard of the computer device, the circuit baseplate having a first micro-processing unit, the first micro-processing unit comprising a Bluetooth wireless communication module and a first storage module, the first micro-processing unit activating a detection mode through the Bluetooth wireless communication module to detect surrounding broadcast packets, and determining by comparing a received signal with a Bluetooth address stored in the first storage module, after confirmation by comparison, a connection request signal and a successfully compared Bluetooth address being generated to the portable object, so that the portable object generating a connection confirmation signal and sending the connection confirmation signal to the circuit baseplate after confirmation by comparison according to the connection request signal and the successfully compared Bluetooth address, the first micro-processing unit of the circuit baseplate sending an identification request command and a random code to the portable object according to the connection confirmation signal, the identification request command requesting the portable object to provide an identification request information and a corresponding code corresponding to the random code to send back to the circuit baseplate, the circuit baseplate obtaining the identification request information and the corresponding code, after confirmation by comparison, a replied signal being generated to the portable object, and the circuit baseplate determining whether to execute an operation on the computer device or disconnect connection with the portable object to re-enter a detection procedure according to the replied signal.

2. The computer intelligent switching system as claimed in claim 1, wherein the identification request information further comprises a company identification code, a product identification code and a product name.

3. The computer intelligent switching system as claimed in claim 2, wherein the random code is stored in a first comparison table of a first database of the first storage module, the corresponding code is stored in a second comparison table of a second database of a second storage module in a second micro-processing unit of the portable object, the first and second comparison tables both contain 256 sets of different 2-byte digital contents, the first and second comparison tables both have the random code and the corresponding code, the random code represents serial numbers (No. 0 to 255), the corresponding code represents 2-byte digital passwords of each of the sets, when the first micro-processing unit of the circuit baseplate sends the identification request command, the random code is sent to the portable object at the same time, after receiving the random code, the portable object finds the corresponding code corresponding to the random code from the second comparison table and sends the corresponding code to the circuit baseplate.

4. The computer intelligent switching system as claimed in claim 1, wherein the first micro-processing unit of the circuit baseplate confirms a signal strength with the portable object through the Bluetooth wireless communication module, converts the signal strength into a distance value, and confirms whether the distance value is less than or greater than a specified distance through a determination module, and the computer device executes turn-on, wake-up, sleep or shutdown mode according to the specified distance.

5. The computer intelligent switching system as claimed in claim 1, wherein a light-emitting diode (LED) is further provided on the motherboard of the computer device and is electrically connected to the first micro-processing unit of the circuit baseplate, and determining to generate a command signal by observing whether the light-emitting diode is lit up or not.

6. The computer intelligent switching system as claimed in claim 5, wherein the command signal further comprises a wake-up signal or a turn-on signal, and the computer device executes operations according to the wake-up signal or the turn-on signal.

7. A computer intelligent switching method comprising following steps of:
a portable object sending a broadcast packet with a Bluetooth address (BD address);
inside a computer device being provided with a circuit baseplate electrically connected to a motherboard of the computer device, a first micro-processing unit comprising a Bluetooth wireless communication module and a first storage module being provided in the circuit baseplate, the first micro-processing unit activating a detection mode via the Bluetooth wireless communication module to detect surrounding broadcast packets, and determining by comparing a received signal with a Bluetooth address stored in the first storage module, after confirmation by comparison, generating a connection request signal and a successfully compared Bluetooth address to the portable object;
the portable object generating a connection confirmation signal and sending the connection confirmation signal to the circuit baseplate after confirmation by comparison according to the connection request signal and the successfully compared Bluetooth address;
the first micro-processing unit of the circuit baseplate sending an identification request command and a random code to the portable object according to the connection confirmation signal;
the identification request command requesting the portable object to provide an identification request information and a corresponding code corresponding to the random code to send back to the circuit baseplate;
the circuit baseplate obtaining the identification request information and the corresponding code, after confirmation by comparison, generating a replied signal to the portable object; and
the circuit baseplate determining whether to execute an operation on the computer device or disconnecting connection with the portable object to re-enter a detection procedure according to the replied signal.

8. The computer intelligent switching method as claimed in claim 7, wherein after the step of generating the connection request signal and the successfully compared Bluetooth address to the portable object, further comprising:
if the Bluetooth address of the portable object being incorrectly compared, meaning failed connection, the portable object sending the broadcast packet and the circuit baseplate activating the detection procedure again.

9. The computer intelligent switching method as claimed in claim 7, wherein after the random code from the circuit baseplate and the corresponding code collected from the portable object are determined by comparison, if a comparison result is correct, a reply signal is generated and sent to the portable object, if a comparison result is wrong, a replied signal is also generated to notify the portable object, the successfully compared Bluetooth address is disconnected at the same time, and the Bluetooth wireless communication module re-enters to activate the detection mode.

10. The computer intelligent switching method as claimed in claim 7, wherein after the step of the circuit baseplate obtaining the identification request information and the corresponding code, after confirmation by comparison, generating the replied signal to the portable object, further comprising:
the first micro-processing unit of the circuit baseplate confirming a signal strength with the portable object through the Bluetooth wireless communication module and converting the signal strength into a distance value;
confirming whether the distance value being less than or greater than a specified distance through a determination module;
if the distance value being determined to be less than the specified distance, further determining whether the computer device being turned on or woken up; and
if the distance value being determined to be greater than the specified distance, the determination module continuing to confirm a distance.

11. The computer intelligent switching method as claimed in claim 10, wherein a light-emitting diode (LED) is further provided on the motherboard of the computer device and is electrically connected to the first micro-processing unit, and determining to generate a command signal by observing whether the light-emitting diode is lit up or not.

12. The computer intelligent switching method as claimed in claim 11, wherein after the step of if the distance value being determined to be less than the specified distance, further comprising:
determining to generate a command signal by observing whether the light-emitting diode of the computer device being lit up or not; and
if the light-emitting diode being in a non-light up state, sending a wake-up signal or a turn-on signal of the command signal to the computer device, and the computer device executing a wake-up operation or a turn-on operation according to the wake-up signal or the turn-on signal.

13. The computer intelligent switching method as claimed in claim 12, wherein after the step of determining to generate the command signal by observing whether the light-emitting diode of the computer device being lit up or not, further comprising:
if the light-emitting diode being lit up, the Bluetooth wireless communication module of the first micro-processing unit confirming a signal strength with the portable object and converting the signal strength into the distance value, and determining whether the distance value being greater than the specified distance through the determination module and generating the command signal; and
if the determination module determining that the distance value being greater than the specified distance, sending a sleep signal or a shutdown signal of the command signal to the computer device to execute a sleep operation or a shutdown operation.

14. The computer intelligent switching method as claimed in claim 13, wherein when the determination module determines that the distance value is greater than the specified distance, the first micro-processing unit is connected to a USB port on the motherboard of the computer device through a USB port in the first micro-processing unit, and the sleep signal is sent to the computer device from the USB port of the first micro-processing unit to make the computer device execute the sleep operation, or the first micro-processing unit is electrically connected to a power button of the motherboard of the computer device through an IO pin in the first micro-processing unit to send the shutdown signal to make the computer device execute the shutdown operation.

15. The computer intelligent switching method as claimed in claim 7, wherein the first micro-processing unit further has a distance determination module, the Bluetooth wireless communication module of the first micro-processing unit determines whether a connection with the portable object is disconnected through the distance determination module, if yes, it is determined that the connection fails, and the portable object sends the broadcast packet and the circuit baseplate activates the detection procedure again, if not, return to the step of determining the distance value.

16. The computer intelligent switching method as claimed in claim 7, wherein the identification request information comprises a company identification code, a product identification code and a product name.

17. The computer intelligent switching method as claimed in claim 7, wherein the random code is stored in a first comparison table of a first database of the first storage module, the corresponding code is stored in a second comparison table of a second database of a second storage module in a second micro-processing unit of the portable object, the first and second comparison tables both contain 256 sets of different 2-byte digital contents, the first and second comparison tables both have the random code and the corresponding code, the random code represents serial numbers (No. 0 to 255), the corresponding code represents 2-byte digital passwords of each of the sets, when the first micro-processing unit of the circuit baseplate sends the identification request command, the random code is sent to the portable object at the same time, after receiving the random code, the portable object finds the corresponding code corresponding to the random code from the second comparison table and sends the corresponding code to the circuit baseplate.
